(19) United States
(12) Patent Application Publication
(10) Pub. No.: US 2005/0289551 A1
(43) Pub. Date: Dec. 29, 2005

(54) Mechanism for prioritizing context swapping

(76) Inventors: Waldemar Wojtkiewicz, Banino (PL); Jacek Szyszko, Gdynia (PL)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/880,247

(22) Filed: Jun. 29, 2004

(51) Int. Cl. G06F 9/46

(52) U.S. Cl. 718/103

(57) ABSTRACT

A method, apparatus, and system are provided for prioritizing context swapping. According to one embodiment, a priority level is assigned to each context of a set of contexts. The contexts are then placed in various priority queues in accordance with their assigned priority level, and a context from one of the priority queues is selected to perform a task.

### BACKGROUND

1. Field of the Invention

Embodiment of this invention relate generally to processors. More particularly, an embodiment of the present invention relates to a mechanism for prioritizing context swapping.

2. Description of Related Art

With the increase in multithreaded processors and multithreaded programs, many of the system resources, such as memory and input/output (I/O) interfaces, are being shared and becoming increasingly common. Such sharing of the common resources has resulted the importance of making context swapping as efficient and reliable as possible. A context (also known as thread) generally refers to a set of registers residing in a processor to perform certain tasks. Typically, context swapping allows a context to perform computation while other contexts wait for I/O interfaces (for external memory accesses) to complete or to receive a signal from another context or hardware unit.

Some solutions have been proposed to make context swapping work seamlessly and efficiently. For example, one technique for context swapping includes round-robin swapping or switching of contexts by using a well-known technique of First In First Out (FIFO). By using FIFO, the subsequent contexts wait in the order they entered the queue and until the previous context has left the queue. Although the use of FIFO in context swapping is relatively more efficient and organized, it is also time consuming, which can result in costly delays in executing of one particular context. This usually happens when another context possesses control for a period after which the yield becomes unpredictable. Furthermore, none of the conventional techniques for context swapping provide any control to the programmer.

FIG. 1 is a block diagram illustrating a conventional technique for context scheduling for execution. A FIFO queue 100 is illustrated having a number of contexts 102-108 in the READY state waiting for their turn to perform a task. The order of the contexts in the FIFO queue 100 is determined by the order they transitioned to the READY state from the SLEEP state. When the executing context (not illustrated) yields control, the next instruction's address is preserved for future resuming of the context. After transitioning from the READY state to the EXECUTING state, the context 102-108, one after another, continues executing the program from the stored location.

Context swapping occurs while the context is in the EXECUTING state and the processor executes a context swapping instruction. With the execution of the instruction, the context 102 that is next in line in the FIFO queue 100 is triggered and requested to take over. The context 102 takes over the EXECUTING state and continues executing the instruction from the point of its last swapping. One problem with this technique occurs when a lower context 104-108, lower than the context 102, in the FIFO queue 100 is needed to perform a particular task immediately once it becomes ready. Using the FIFO technique, none of the contexts 104-108 can be put in front of the context 102, as they are required to wait their turn in the FIFO queue 100. Furthermore, because of the restrictive nature of the FIFO technique, the programmer (e.g., developer, administrator) carries no influence in choosing a particular context 102-108 to perform a given task.

### BRIEF DESCRIPTION OF THE DRAWINGS

The appended claims set forth the features of the embodiments of the present invention with particularity. The embodiments of the present invention, together with its advantages, may be best understood from the following detailed description taken in conjunction with the accompanying drawings of which:

FIG. 1 is a block diagram illustrating a conventional technique for context scheduling for execution;

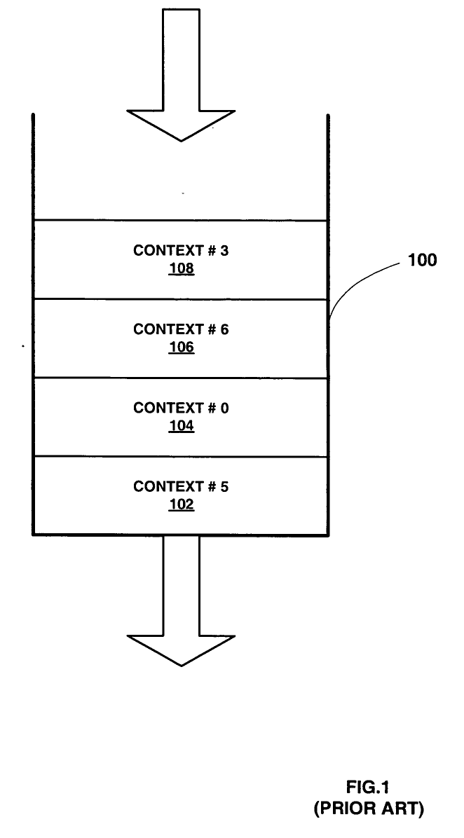

FIG. 2 is a block diagram illustrating an exemplary computer system used in implementing one or more embodiments of the present invention;

FIG. 3 is a block diagram illustrating an embodiment of a processor;

FIG. 4 is a block diagram illustrating an embodiment of a context state machine with its transitions in a processor having contexts;

FIG. 5 is a block diagram illustrating an embodiment of a processor having a microengine having contexts corresponding to instructions in a code residing at a control store;

FIG. 6 is a block diagram illustrating an embodiment of priority queues for prioritizing contexts and contexts swapping in a processor; and

FIG. 7 is a flow diagram illustrating an embodiment of a process for context swapping based on priority levels.

### DETAILED DESCRIPTION

Described below is a system and method for prioritizing context swapping in a computer system. Throughout the description, for the purposes of explanation, numerous specific details are set forth in order to provide a thorough understanding of the embodiments of the present invention. It will be apparent, however, to one skilled in the art that the present invention may be practiced without some of these specific details. In other instances, well-known structures and devices are shown in block diagram form to avoid obscuring the underlying principles of the present invention.

In the following description, numerous specific details such as logic implementations, opcodes, resource partitioning, resource sharing, and resource duplication implementations, types and interrelationships of system components, and logic partitioning/integration choices may be set forth in order to provide a more thorough understanding of various embodiments of the present invention. It will be appreciated, however, to one skilled in the art that the embodiments of the present invention may be practiced without such specific details, based on the disclosure provided. In other instances, control structures, gate level circuits and full software instruction sequences have not been shown in detail in order not to obscure the invention. Those of ordinary skill in the art, with the included descriptions, will be able to implement appropriate functionality without undue experimentation.

Various embodiments of the present invention will be described below. The various embodiments may be performed by hardware components or may be embodied in machine-executable instructions, which may be used to cause a general-purpose or special-purpose processor or a machine or logic circuits programmed with the instructions to perform the various embodiments. Alternatively, the various embodiments may be performed by a combination of hardware and software.

Various embodiments of the present invention may be provided as a computer program product, which may include a machine-readable medium having stored thereon instructions, which may be used to program a computer (or other electronic devices) to perform a process according to various embodiments of the present invention. The machine-readable medium may include, but is not limited to, floppy diskette, optical disk, compact disk-read-only memory (CD-ROM), magneto-optical disk, read-only memory (ROM) random access memory (RAM), erasable programmable read-only memory (EPROM), electrically erasable programmable read-only memory (EEPROM), magnetic or optical card, flash memory, or another type of media/machine-readable medium suitable for storing electronic instructions. Moreover, various embodiments of the present invention may also be downloaded as a computer program product, wherein the program may be transferred from a remote computer to a requesting computer by way of data signals embodied in a carrier wave or other propagation medium via a communication link (e.g., a modem or network connection).

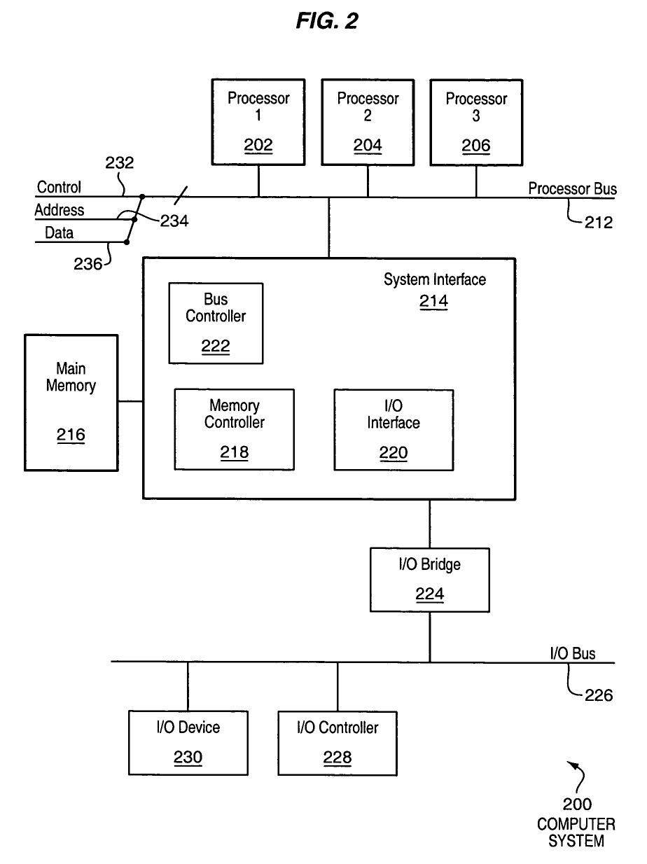

FIG. 2 is a block diagram illustrating an exemplary computer system used in implementing one or more embodiments of the present invention. The computer system (system) includes one or more processors 202-206. The processors 202-206 may include one or more single-threaded or multi-threaded processors. A typical multi-threaded processor may include multiple threads or logical processors, and may be capable of processing multiple instruction sequences concurrently using its multiple threads. Processors 202-206 may also include one or more internal levels of cache (not shown) and a bus controller or bus interface unit to direct interaction with the processor bus 212.

Processor bus 212, also known as the host bus or the front side bus, may be used to couple the processors 202-206 with the system interface 214. Processor bus 212 may include a control bus 232, an address bus 234, and a data bus 236. The control bus 232, the address bus 234, and the data bus 236 may be multidrop bi-directional buses, e.g., connected to three or more bus agents, as opposed to a point-to-point bus, which may be connected only between two bus agents.

System interface 214 (or chipset) may be connected to the processor bus 212 to interface other components of the system 200 with the processor bus 212. For example, system interface 214 may include a memory controller 218 for interfacing a main memory 216 with the processor bus 212. The main memory 216 typically includes one or more memory cards and a control circuit (not shown). System interface 214 may also include an input/output (I/O) interface 220 to interface one or more I/O bridges or I/O devices with the processor bus 212. For example, as illustrated, the I/O interface 220 may interface an I/O bridge 224 with the processor bus 212. I/O bridge 224 may operate as a bus bridge to interface between the system interface 214 and an I/O bus 226. One or more I/O controllers and/or I/O devices may be connected with the I/O bus 226, such as I/O controller 228 and I/O device 230, as illustrated. I/O bus 226 may include a peripheral component interconnect (PCI) bus or other type of I/O bus.

System 200 may include a dynamic storage device, referred to as main memory 216, or a random access memory (RAM) or other devices coupled to the processor bus 212 for storing information and instructions to be executed by the processors 202-206. Main memory 216 also may be used for storing temporary variables or other intermediate information during execution of instructions by the processors 202-206. System 200 may include a read only memory (ROM) and/or other static storage device coupled to the processor bus 212 for storing static information and instructions for the processors 202-206.

Main memory 216 or dynamic storage device may include a magnetic disk or an optical disc for storing information and instructions. I/O device 230 may include a display device (not shown), such as a cathode ray tube (CRT) or liquid crystal display (LCD), for displaying information to an end user. For example, graphical and/or textual indications of installation status, time remaining in the trial period, and other information may be presented to the prospective purchaser on the display device. I/O device 230 may also include an input device (not shown), such as an alphanumeric input device, including alphanumeric and other keys for communicating information and/or command selections to the processors 202-206. Another type of user input device includes cursor control, such as a mouse, a trackball, or cursor direction keys for communicating direction information and command selections to the processors 202-206 and for controlling cursor movement on the display device.

System 200 may also include a communication device (not shown), such as a modem, a network interface card, or other well-known interface devices, such as those used for coupling to Ethernet, token ring, or other types of physical attachment for purposes of providing a communication link to support a local or wide area network, for example. Stated differently, the system 200 may be coupled with a number of clients and/or servers via a conventional network infrastructure, such as a company's Intranet and/or the Internet, for example.

It is appreciated that a lesser or more equipped system than the example described above may be desirable for certain implementations. Therefore, the configuration of system 200 may vary from implementation to implementation depending upon numerous factors, such as price constraints, performance requirements, technological improvements, and/or other circumstances.

It should be noted that, while the embodiments described herein may be performed under the control of a programmed processor, such as processors 202-206, in alternative embodiments, the embodiments may be fully or partially implemented by any programmable or hardcoded logic, such as field programmable gate arrays (FPGAs), transistor transistor logic (TTL) logic, or application specific integrated circuits (ASICs). Additionally, the embodiments of the present invention may be performed by any combination of programmed general-purpose computer components and/or custom hardware components. Therefore, nothing disclosed herein should be construed as limiting the various embodiments of the present invention to a particular embodiment wherein the recited embodiments may be performed by a specific combination of hardware components.

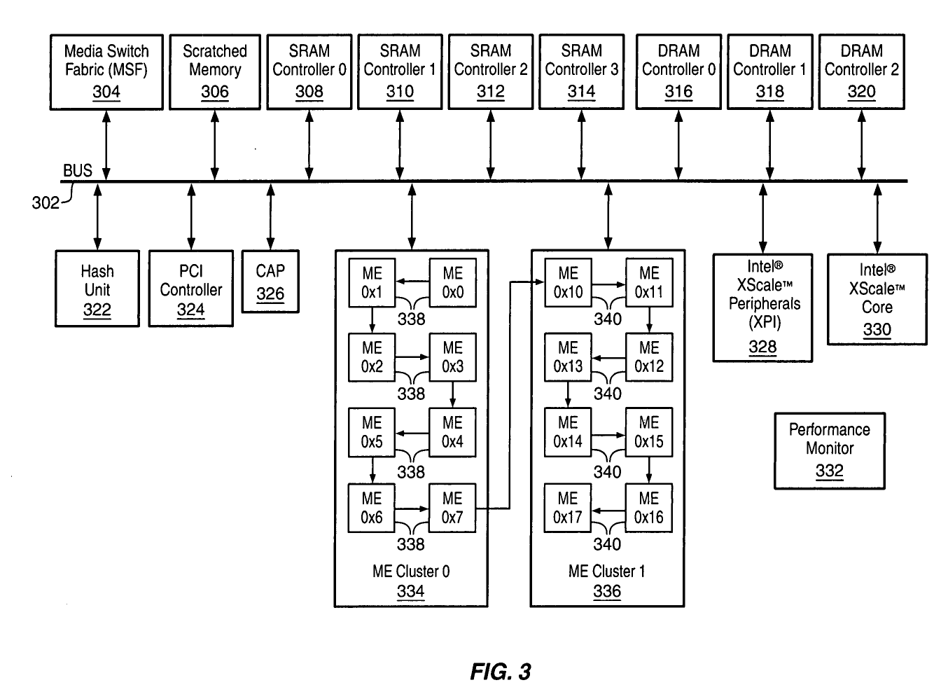

FIG. 3 is a block diagram illustrating an embodiment of a processor 300. The processor 300 may be a network processor (including one of the processors 202-206 of FIG. 2) for relatively fast and efficient transmission of data traffic in computer networks. For the network processor 300 to be fast, it includes a number of sub-processors connected with various components and sharing common resources like memory and I/O interfaces. Examples of network processors include Intel(® Corporation's IXP series of network processors. In the illustrated embodiment, the processor 300 includes a set of components and subcomponents connected to and in communication with each other via a bus 302. In one embodiment, the processor 300 includes a number of dynamic RAM (DRAM) controllers 316-320 for data buffer storage and a number of static RAM (SRAM) controllers 308-314 for control information storage. The DRAM controllers 316-320 and SRAM controllers 308-314 may function independent of each other. The processor 300 also includes a scratchpad memory 306 for use as general-purpose storage.

The processor 300 also includes a media and switch fabric interface (MSF) 304 to serve as an interface for network framers and/or switch fabric and to contain receive and transmit buffers, and a peripheral component interconnect (PCI) controller 324 (e.g., 64-bit PCI Rev 2.2 compliant I/O bus). PCI controller 324 can be used to connect to a host processor and/or to attach PCI compliant peripheral devices. The performance monitor 332 includes counters, which can be programmed to count selected internal chip hardware events, which can be used to analyze and tune performance.

To achieve better performance, the processor 300 further includes one or more processors at the core 330 for configuration and one or more microengine (ME) clusters 334-336 having MEs for passing data traffic. Depending on the processor design, a cluster 334-336 may include any number of MEs 338-340, such as 8 MEs or 16 MEs. The core 330, for example, includes a general purpose 32-bit reduced instruction set computer (RISC) processor used for initializing and managing the network processor and for higher layer network processing tasks. Each of the MEs 338-340 (e.g., ME 0x1) may include a sixteen 32-bit programmable engine specializing in network processing, such as performing main data plane processing per packet.

The peripherals 328 may include an interrupt controller, timer, universal asynchronous receiver transmitter (UART), general purpose I/O (GPIO) and interface to low-speed off chip peripherals, such as maintenance port of network devices, and flash ROM. Furthermore, the hash unit 322 may include a polynomial hash accelerator for use for the core 330 and MEs 338-340 to offload hash calculations. The control status register access proxy (CAP) 326 is to provide special inter-processor communication features to allow flexible and efficient inter-ME 338-340 and ME 338-340 to core 330 communications.

In one embodiment, the MEs 338-340 perform most of programmable pre-packet processing in the network processor 300. In the illustrated embodiment, the processor 300 is shown to have 16 MEs 338-340 with 8 MEs in each of the ME clusters 334-336. For example, ME cluster 0 334 includes 8 MEs (ME 0x1-ME 0x7) 338, while ME cluster 1 336 also includes 8 MEs (ME 0x10-ME 0x16) 340. Each of the MEs 338-340 may have access to shared resources (e.g., SRAM 308-314, DRAM 316-320, MSF 304) as well as private connections between adjacent MEs (e.g., next neighbors). Furthermore, an ME 338-340 contains several contexts (e.g., 8 to 16 contexts) that are hardware-based and may include their own register set, program counter, and context specific local registers. The MEs 338-340 are used to provide support for software controlled multithreaded operation.

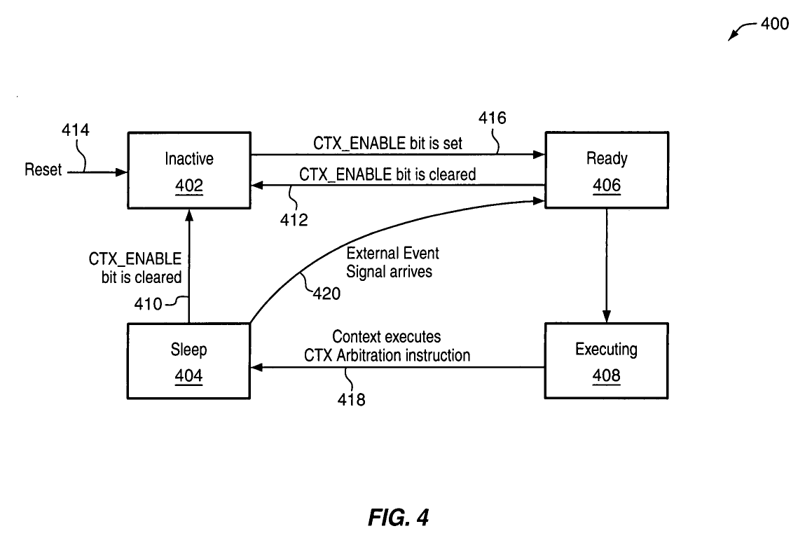

FIG. 4 is a block diagram illustrating an embodiment of a context state machine with its transitions in a processor 400 having contexts. Having a register set, program counter, and context specific local registers in a context, helps eliminate the need to move context specific information to and from shared memory and ME registers for each context swap. In one embodiment, in context swapping, one context is allowed to stay in the EXECUTING state 408 to perform computation, while other contexts wait in various other states, such as INACTIVE state 402, SLEEP state 404, and READY state 406. Stated differently, each of the contexts in a ME (e.g., 8 contexts residing in one ME) adopts one of the four states 402-408, illustrated here.

The INACTIVE state 402 refers to the state when an application may not require all contexts of the ME and so, various contexts are turned inactive. The INACTIVE state 402 is achieved when the enable bit in the register (e.g., CTX_ENABLE CSR) is set to 0 (e.g., the bit is cleared) 410-412. This includes removing the context from the READY state 406 to the INACTIVE state 402 by clearing the bit 412 or removing the context from the SLEEP state 404 to the INACTIVE state 402 also by clearing the bit 410. The context is removed from the INACTIVE state 402 to the READY state 406 by setting the bit 416. The INACTIVE state 402 for the context may also be achieved at initialization or reset 414.

The EXECUTING state 408 refers to a context being in the execution mode when performing various computations and tasks. In one embodiment, the EXECUTING state 408 means a context (e.g., the context number) is active and functioning in the corresponding register (e.g., ACTIVE_CTX_STATUS CSR) for execution purposes. The executing context may be used, for example, to fetch instructions from the control store. The context in the EXECUTING state 408 may stay in there until it executes an instruction that causes it to go to sleep. In one embodiment, the transforming or transferring of the context from the EXECUTING state 408 to the SLEEP state 404 may be performed using a software code without the use of additional hardware.

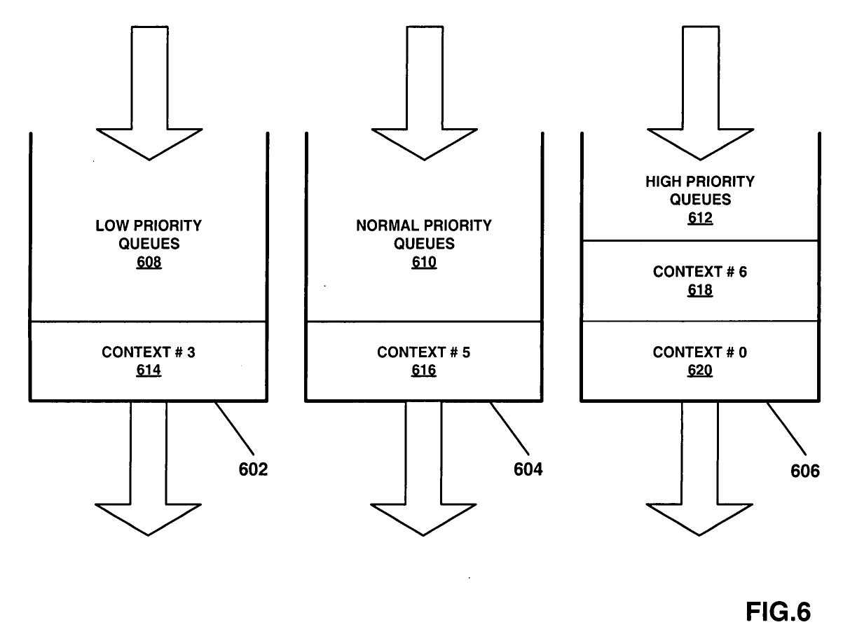

Another context state includes the READY state 406, which refers to a context being ready for execution, but it is not yet executing because another context is in the EXECUTING state 408. In one embodiment, when the context currently in the EXECUTING state 408 goes to sleep in the SLEEP state 404, the ME's context arbiter selects the next context to go to the EXECUTING state 408 from one of the contexts in the READY state 406. In one embodiment, the context is removed from the READY state 406 goes to the EXECUTING state 408 based on the priority level assigned to it, as disclosed with reference to FIG. 6. The assignment of the priority level to each of the contexts provides efficiency and greater control over context swapping.

The SLEEP state 404 refers to a context waiting for an event to occur to trigger the awakening of the context in the SLEEP state 404. The event may include an external event (e.g., specified in the INDIRECT_WAKEUP_EVENTS CSR or CTX_#_WAKEUP_EVENTS CSR), such as an I/O access. The executing context is removed from the EXECUTING state 408 and goes to the SLEEP state 404 when the context executes the CTX_ARB instruction, yielding the place in the EXECUTING state 408 to another context.

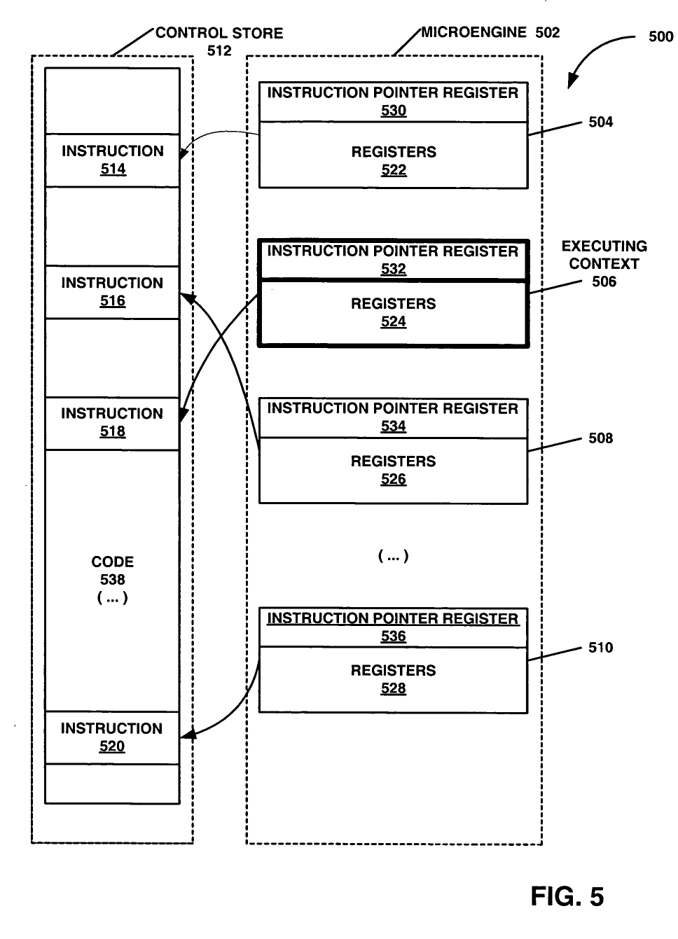

FIG. 5 is a block diagram illustrating an embodiment of a processor 500 having an ME 502 having contexts 504-510 corresponding to instructions 514-520 in a code 538 residing at a control store 512. In one embodiment, the ME 502 is regarded as an independent processing unit of the network processor 500 for running a code (e.g., microcode) 538 from its control store (e.g., microstore) 512. The control store refers to a relatively small piece of memory placed (together with the ME 502) inside the network processor 500. At the processor initialization phase, the control store 512 is filled with compiled code 538 and, once the control store 512 is filled with the code 538, the ME 502 starts executing the code 538. Stated differently, the ME 502, using its contexts 504-510, reads instructions 514-520 of the code 538 from the control store 512 and performs actions or tasks as determined by the instructions 514-520 themselves. The code is usually formed in a loop and each loop cycle of the loop performed by a single context may process, for example, one network packet.

The ME 502 reads and executes an instruction 514-520 from the control store 512 (e.g., from the location pointed by the instruction pointer register (IPR) 530-536 of the contexts 504-510). The content of the IPR 530-536 is then increased by one and the next instruction 514-520 is then executed. Also, an instruction 514-520 may change the content of the IPR 530-536 which could result in starting executing instructions from a different control store (or memory) location (e.g., such instructions are called jump or branch instructions). A jump instruction may be sued to make a loop in the program and make contexts 504-510 that reach the end of the loop to jump to the beginning. In the illustrated embodiment, the ME 502 runs the code 538 form the control store 512 using a number of contexts 504-510 with each context 504-510 having the address of the next instruction 514-520 to be executed by the context 504-510. It is contemplated that a processor 500 may include any number of MEs 502 and each of the MEs 502 may include any number of contexts 504-510 and, similarly, the code 538 may include any number of instructions 514-520 to be executed.

As illustrated, each context 504-510 includes a set of registers 522-536. The set of registers 522-536 includes one IPR 530-536 for having an instruction pointer to point to the address of the next instruction 514-520 to be processed. For example, the IPR 530 of the context 504 points to the address of the instruction 514 to be processed.

Having multiple contexts 504-510 in an ME 502 helps better utilize the processing capabilities of the ME 502 and the processor 500. For example, during packet processing, when referring to the processor's external memory (e.g., to read the packet's data or any kind of database entry), a context (e.g., context 504) of the ME 502 may encounter a wait for the memory reference to be completed (e.g., waiting for the I/O operation to be complete). However, having multiple contexts 504-510 allows the context 504 to, instead of waiting and occupying the EXECUTING state, yield the control of the EXECUTING state to another context by executing an instruction, such as the CTX_ARB instruction. With the execution of the context arbiter instruction, another context (e.g., context 506) is selected from the contexts in the READY state. In one embodiment, context 506 is selected by a programmer or by the context arbiter, automatically, based on the priority level of such context 506, as disclosed with reference to FIG. 6. In the illustrated embodiment, context 506 is shown as the active context, which indicates the context 506 is in the EXECUTING state.

FIG. 6 is a block diagram illustrating an embodiment of priority queues 602-606 for prioritizing contexts 614-620 and contexts swapping in a processor 600. In one embodiment, context swapping of the contexts 614-620 is performed using a set of priority queues 602-606 in which the contexts 614-620 are placed in accordance with the priority assigned to each of the contexts 614-620. The priority to the contexts 614-620 may be assigned based on a number of factors, such as based on the significance of the instruction in the code being executed. For example, if the instruction is of low priority, the context 614-620 is regarded as a low priority context 614 and is assigned to and placed in the low priority queue 602. Similarly, the normal priority context 616 is assigned normal priority and placed in the normal priority queue 604, and the high priority contexts 618-620 are assigned high priority and placed in the high priority queue 606. In one embodiment, the priority level may be assigned to the context 614-620, as necessary, at the time of context swapping or when one or more external events have arrived. The arrival of the external events may help move a sleeping context from the SLEEP state into the READY state with a different priority level and place the now ready context in the corresponding priority queue 602-606. It is contemplated that any number and type of priority levels (e.g., very low, low, . . . high, very high, or A, B, C, and D, or 1, 2, 3, and 4, or morning, afternoon, evening, night, etc.) may be assigned to the contexts 614-620. It is further contemplated that the priority of any given context 614-620 may be changed or removed, as necessitated or desired.

The contexts 614-620 may reside in any number of transition states, such as INACTIVE state and SLEEP state, and enter into the READY state when, for example, the context 614-620 is enabled or when an external event signal has arrived. In one embodiment, once the contexts 614-620 have transitioned into the READY state, the contexts 614-620 are assigned a level of priority and placed into the appropriate queue 614-620. For example, in one embodiment, the level of priority is assigned to the contexts 614-620 at the time of context swapping by adding to the context arbitration instruction (e.g., CTX_ARB instruction) a value indicating the priority value. Using the illustrated example of FIG. 6, values for assigning three levels of priority (e.g., low, normal, and high) may include the following:
ctx_arb [sig], LOW_PRIORITY
ctx_arb [sig], NORMAL_PRIORITY
ctx_arb [sig], HIGH_PRIORITY
where, the LOW_PRIORITY, NORMAL_PRIORITY, AND
HIGH_PRIORITY are compiler keywords.

The contexts 614-620 are assigned and scheduled according to their priority levels and so, when a context 614-620 is needed for execution purposes, the high priority contexts 618-620 are first chosen to perform execution. When selecting between the contexts 618-620 from the high priority queue 606, in one embodiment, the context entering the queue 606 first (e.g., context 620) may be automatically selected. The executing context, now yielding control, may go back to the SLEEP state and make place for context 620, the first in line high priority context, to enter the EXECUTING state. In another embodiment, any context 618-620 from the high priority queue 606 may be selected as determined by the programmer. It is contemplated that the programmer may also select any of the other contexts 614-616 from queues 602-604 other than the high priority queue 606.

Stated differently, in one embodiment, the contexts 614-620 having priority levels assigned and placed in the priority queues 602-606 may be selected by the programmer, giving the programmer the ability and choice to select whichever context 614-620 he or she desires or needs based on a given criteria. In another embodiment, once the contexts 614-620 are assigned various priority levels and placed in the corresponding priority queues 602-606, any number of mechanisms (e.g., round-robin, FIFO, and last-in-first-out (LIFO)), may be applied to automate the selection process of the contexts 614-620 from the queues 602-606.

The priority levels may be assigned once the context 614-620 is in the READY state and not necessarily in the SLEEP state or INACTIVE state. The contexts 614-620 may be assigned multiple priority levels based on various factors, such as the nature and significance of the corresponding code instruction. The priority levels may also be changed with the change in the criteria or in the significance of the instruction being executed. Furthermore, once a new context 614-620 has entered the EXECUTING state (depending on the programmer and/or the selection process), the executing context may then lose its priority level, as there may not be a need for such priority level in the EXECUTING state. Also, if the context gets back into the READY state at a later stage, it may not have the same priority level assigned to it. In some cases, such as when not clear what level of priority is to be assigned to a given context 614-620, a default priority level (e.g., normal priority) may be assigned and the context 614-620 is placed in the normal priority queue 604.

In one embodiment, the assignment of priority levels, using various parameters, allows programmers to chose and change the order of contexts 614-620 in the READY state. For example, a loop in the code may have an instance where a context in the EXECUTING state requests external hardware regarding whether it can transmit a packet, and the executing context executes the CTX_ARB instruction. The execution of the CTX_ARB instruction may necessitate an action from the READY state for a context 618-620 to take over the EXECUTING state. Also, the CTX_ARB instruction may carry information about the priority of the context executing the instruction and then leaving the EXECUTING state. In one embodiment, the next context 620 from the high priority queue 606 then transitions into the EXECUTING state. In another embodiment, a signal instruction (e.g., br_signal instruction) may test the presence of a signal (e.g., event arrival) and, in case of the signal availability, it may perform a jump to a different control store location to omit the CTX_ARB instruction to have the executing context refrain from going to the SLEEP state.

Several other usages can be achieved by having multiple priority level queues 602-606. For example, the multiple queues 602-606 are utilized when there are two or more program loops in the code and the contexts 614-620 are grouped to run the loops (e.g., 3 contexts can run one loop and 5 contexts can run another loop). Furthermore, flexible adjustment of priority levels of different parts of the program code is achieved, which simplifies time-critical places of the code and can save a number of instructions that are otherwise executed.

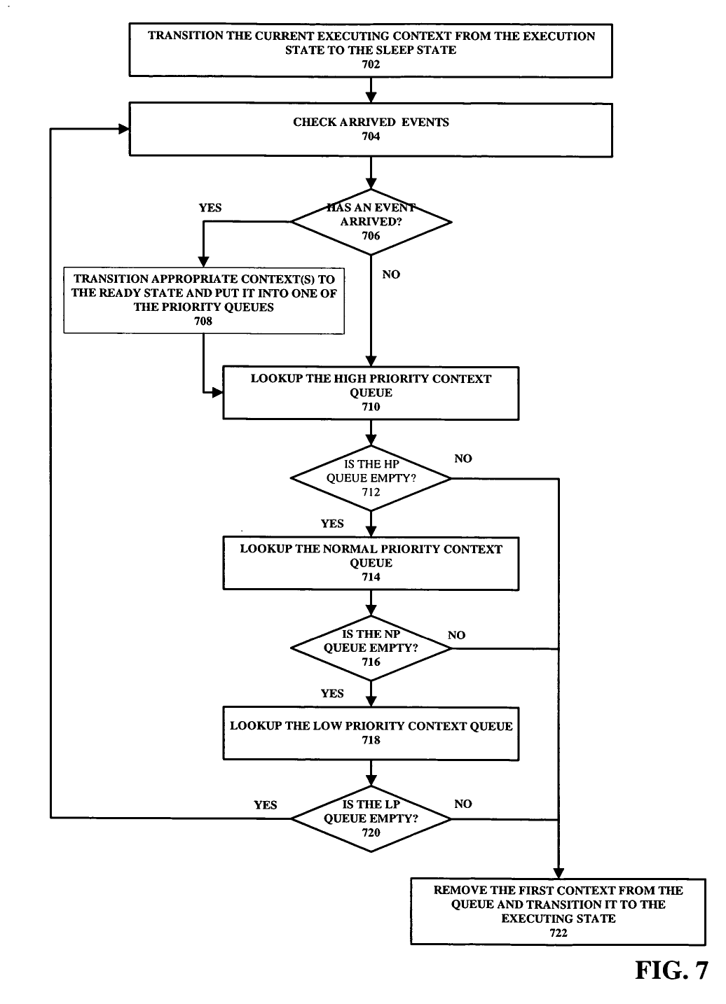

FIG. 7 is a flow diagram illustrating an embodiment of a process for context swapping based on priority levels. First, the executing context yields its place and is transitioned from the EXECUTING state to the SLEEP state at processing block 702. The arrival of events (e.g., external events, accessing the memory, etc.) is checked at processing block 704. At decision block 706, a determination is made as to whether such event has arrived. If yes, a proper context is transitioned from the INACTIVE state or SLEEP state to the READY state into one of the priority queues at processing block 708. In one embodiment, the executing context executes a context arbitration (CTX_ARB) instruction, which triggers the search or selection for another context to replace the yielding current executing context. An appropriate context, if available, may be selected from any number of states and transitioned into the READY state into a priority queue (e.g., high priority queue). A context may be regarded appropriate based on various factors, such as the instruction to be executed, context performance, and the like.

Referring back to the decision block 706, if the event has not arrived, or the appropriate context has been put into one of the queues, the high priority queue is first searched for a context at processing block 710. At decision block 712, a determination is made as to whether the high priority queue is empty. If the high priority queue has one or more contexts, a context is selected, removed, and transitioned into the EXECUTING state at processing block 722. If the contexts are not found, the normal priority queue is searched at processing block 714. At decision block 716, a determination is made as to whether the normal priority queue is empty. If the normal priority queue has one or more contexts, a context is selected, removed, and transitioned into the EXECUTING state at processing block 722. If the contexts are not found, the low priority queue is searched at processing block 718. At decision block 720, a determination is made as to whether the low priority queue is empty. If the low priority queue has one or more contexts, a context is selected, removed, and transitioned into the EXECUTING state at processing block 722. If the contexts are not found, the ME remains in the idle state and the process continues with checking for arrived events at processing block 704.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

While certain exemplary embodiments have been described and shown in the accompanying drawings, it is to be understood that such embodiments are merely illustrative of and not restrictive, and that the embodiments of the present invention are not to be limited to specific constructions and arrangements shown and described, since various other modifications may occur to those ordinarily skilled in the art upon studying this disclosure.

1. A method, comprising:
assigning a priority level to each of a plurality of contexts;
placing the plurality of contexts in priority queues in accordance with the assigned priority level; and
selecting a context from one of the priority queues to perform a task.

2. The method of claim 1, wherein the plurality of contexts resides on a microengine (ME) of a processor and corresponds to an instruction in a program code, wherein the ME performs programmable pre-packet processing for the processor.

3. The method of claim 1, further comprising an executing context in an executing state to yield control of the executing state to another context of the plurality of contexts, and triggering the assigning of the priority level to the plurality of contexts by executing an instruction, wherein the instruction includes a context arbiter instruction.

4. The method of claim 1, wherein the priority queues reside in a ready state, the priority queues comprising one or more of the following: high priority queue, normal priority queue, and low priority queue.

5. The method of claim 4, wherein the selecting of the context comprises:
removing a high priority context from the high priority queue; and
inserting the high priority context into the executing state.

6. The method of claim 5, wherein the selecting of the context further comprises:
removing a normal priority context from the normal priority queue, if the high priority queue is empty; and
inserting the normal priority context into the executing state.

7. The method of claim 6, wherein the selecting of the context further comprises:
removing a low priority context from the low priority queue, if the high priority queue and the normal priority queue are empty; and
inserting the low priority context into the executing state.

8. The method of claim 4, further comprising:
selecting a context from one or more of the following states: an inactive state and a sleep state, if the ready state is empty;
removing the selected context; and
inserting the removed context in the executing state.

9. A processor, comprising:
a microengine including a plurality of contexts corresponding to a plurality of instructions of a program code, each of the plurality of contexts is assigned a priority level and placed in a priority level queue in accordance with the assigned priority level; and
a bus to couple the microengine with a plurality of components.

10. The processor of claim 9, wherein the assigning of the priority level comprises assigning the priority level in accordance with significance of a program code instruction to be executed.

11. The processor of claim 9, wherein the priority level queue resides in a ready state, the priority level queue includes one or more of the following: a high priority level queue, a normal priority level queue, and a low priority level queue.

12. The processor of claim 9, wherein the microengine selects a context of the plurality of contexts from the priority level queue to replace an executing context returning to a sleep state from an executing state.

13. The processor of claim 9, wherein the plurality of components comprises one or more of the following: a secondary processor, dynamic random access memory (DRAM) controllers, static random access memory (SRAM) controllers, scratched memory, media switch fabric (MSF), performance monitor, a hash unit, a peripheral component interconnect (PCI) controller, control status register access proxy (CAP).

14. A system, comprising
a storage medium; and
a processor coupled with the storage medium, the processor having
a plurality of microengine clusters, each of the clusters having a plurality of microengines; and
the plurality of microengines, each of the plurality of microengines having
a plurality of clusters in one or more of the following states:
inactive state, sleep state, ready state, and executing state, wherein one or more clusters of the plurality of clusters in the ready state are assigned a priority level and placed in one or more priority level queues; and
a control store in communication with the plurality of microengines, the control store having a program code including a plurality of instructions.

15. The system of claim 14, wherein the one or more priority level queues comprise one or more of the following: a high level priority queue, a normal level priority queue, and a low level priority queue.

16. The system of claim 14, wherein a cluster from the plurality of clusters is selected to replace an executing cluster in the executing state, the executing cluster yields control of the executing state to the cluster and returns to the sleep state.

17. The system of claim 16, wherein the executing cluster, when yielding the control, executes an instruction to trigger the selecting of the cluster from the plurality of clusters.

18. The system of claim 17, wherein the instruction comprises a context arbiter instruction.

19. A machine-readable medium having stored thereon data representing sets of instructions which, when executed by a machine, cause the machine to:
assign a priority level to each of a plurality of contexts, wherein each of the plurality of contexts;
place the plurality of contexts in priority queues in accordance with the assigned priority level; and
select a context from one of the priority queues to perform a task.

20. The machine-readable medium of claim 19, wherein the plurality of contexts resides on a microengine (ME) of a processor and corresponds to an instruction in a program code, wherein the ME performs programmable pre-packet processing for the processor.

21. The machine-readable medium of claim 19, wherein the sets of instructions which, when executed by the machine, further cause the machine to cause an executing context to yield control of an executing state to another context of the plurality of contexts, and trigger the assigning of the priority level to the plurality of contexts by executing an instruction, wherein the instruction includes a context arbiter instruction.

22. The machine-readable medium of claim 19, wherein the priority queues reside in a ready state, the priority queues comprising one or more of the following: high priority queue, normal priority queue, and low priority queue.

23. The machine-readable medium of claim 22, wherein the sets of instructions which, when executed by the machine, further cause the machine to:
remove a high priority context from the high priority queue; and
insert the high priority context into the executing state.

24. The machine-readable medium of claim 23, wherein the sets of instructions which, when executed by the machine, further cause the machine to:
remove a normal priority context from the normal priority queue, if the high priority queue is empty; and
insert the normal priority context into the executing state.

25. The machine-readable medium of claim 24, wherein the sets of instructions which, when executed by the machine, further cause the machine to:
remove a low priority context from the low priority queue, if the high priority queue and the normal priority queue are empty; and
insert the low priority context into the executing state.

26. The machine-readable medium of claim 22, wherein the sets of instructions which, when executed by the machine, further cause the machine to:
select a context from one or more of the following states: an inactive state and a sleep state, if the ready state is empty;
remove the selected context; and
insert the removed context into the executing state.
